(19) United States
(12) Patent Application Publication
(10) Pub. No.: US 2018/0053470 A1
(43) Pub. Date: Feb. 22, 2018

(54) DISPLAY DEVICE AND DRIVING METHOD OF THE SAME

(71) Applicant: Japan Display Inc., Tokyo (JP)

(72) Inventors: Tetsuo MORITA, Tokyo (JP); Hiroyuki KIMURA, Tokyo (JP); Makoto SHIBUSAWA, Tokyo (JP); Hiroshi TABATAKE, Tokyo (JP); Yasuhiro OGAWA, Tokyo (JP)

(21) Appl. No.: 15/618,202

(22) Filed: Jun. 9, 2017

(30) Foreign Application Priority Data
Aug. 17, 2016 (JP) 2016-159876

(51) Int. Cl. G09G 3/3258

(52) U.S. Cl. CPC G09G 3/3258; G09G 2310/08; G09G 2300/0871; G09G 2300/0842; G09G 2300/043

(57) ABSTRACT

A driving method of a display device is provided. In a first period, threshold voltages are simultaneously compensated for all first transistors which are provided in a plurality of pixels arranged in a matrix form with n rows and m columns. In a second period, turning switches are turned off, and image data is written to the first transistors in the plurality of pixels row-by-row. In a third period, all light-emitting elements are made to simultaneously emit light. n and m are each an integer larger than 1. Each of the first transistors is configured so that the image data is input to a control terminal, a first terminal is electrically connected to a power-source line, and a second terminal is electrically connected to the light-emitting element. The power-source line is supplied with a high-level potential in the first and third periods and a low-level potential in the second period.

### CROSS REFERENCE TO RELATED APPLICATIONS

This application is based on and claims the benefit of priority from the prior Japanese Patent Application No. 2016-159876, filed on Aug. 17, 2016, the entire contents of which are incorporated herein by reference.

### FIELD

An embodiment of the present invention relates to a display device and a driving method thereof. For example, an embodiment of the present invention relates to a driving method of a pixel circuit including a display element structured with an organic electroluminescence (hereinafter, referred to an organic EL) material or a driving method including a display device having the pixel circuit.

### BACKGROUND

A liquid crystal display device, an organic electroluminescence display device (hereinafter, referred to as an organic EL display device), and the like have been known as a typical display element. In these display devices, a plurality of pixels having a display element such as a liquid crystal element and an organic light-emitting element (hereinafter, referred to as a light-emitting element) is provided to form a display region. Each pixel has a pixel circuit including a display element, and driving of the display element is controlled by this pixel circuit. A pixel circuit of an organic EL display device is structured by a semiconductor element such as a transistor and a capacitor element in addition to a light-emitting element, and appropriate design of structures and layout of these elements and their driving method allows miniaturization and high-speed operation of a pixel to be realized. In other words, appropriate design of a pixel circuit enables high-quality image display. For example, Japanese patent application publication 2011-22341 discloses, as an example of a pixel circuit, a pixel circuit having two transistors, one capacitor element, and one light-emitting element and a display device including the pixel circuit. Here, a display device is driven so that compensation of variation in a threshold voltage (threshold compensation) of the transistors is simultaneously carried out in all of the pixels, and then writing of image data is performed in all of the pixels.

### SUMMARY

An embodiment of the present invention is a driving method of a display device. The display device has a plurality of pixels arranged in a matrix form with n rows and m columns. The pixels each include a first transistor having a control terminal, a first terminal, and a second terminal, a turning switch, and a light-emitting element. n and m are each an integer larger than 1. Each of the first transistors is configured so that image data is input to the control terminal, the first terminal is electrically connected to a power-source line, and the second terminal is electrically connected to a light-emitting element. The driving method is divided into first to third periods. In the first period, the threshold voltages of the first transistors are simultaneously compensated. In the second period following the first period, the turning switch is turned off, and the image data is input to the first transistors in the plurality of pixels row-by-row. In the third period following the second period, the light-emitting elements are made to simultaneously emit light. The power-source line is applied with a high-level potential in the first period and the third period and is applied with a low-level potential in the second period.

An embodiment of the present invention is a driving method of a display device. The display device has a plurality of pixels arranged in a matrix form with n rows and m columns. Each of the plurality of pixels possesses first to third transistors each having a control terminal, a first terminal, and a second terminal, a storage capacitor, and a light-emitting element. The control terminal of the first transistor is electrically connected to the first terminal of the third transistor and one terminal of the storage capacitor. The first terminal of the first transistor is electrically connected to the first terminal of the second transistor. The second terminal of the first transistor is electrically connected to the other terminal of the storage capacitor and an anode of the light-emitting element. The second terminal of the second transistor is electrically connected to a respective one of a plurality of power source lines configured to be supplied with a high-level potential and a low-level potential. The driving method is divided into first to fourth periods. In the first period, an initialization potential is supplied to the first transistors by turning on the third transistors, while maintaining an on state of the second transistors and supplying the low-level potential to the power source lines in the plurality of pixels. In the second period following the first period, the high-potential is supplied to the power-source lines while maintaining an on state of the second transistors and the third transistors, and then the low-level potential is supplied to the power source lines while turning off the second transistors and the third transistors in the plurality of pixels. In the third period following the second period, image data is sequentially supplied to the control terminals of the first transistors by turning on the third transistors row-by-row. In the fourth period following the third period, the light-emitting elements are made to simultaneously emit light by turning on the second transistors and supplying the high-level potential to the power source lines while maintaining an off state of the third transistors in the plurality of pixels.

An embodiment of the present invention is a driving method of a display device. The display device has a plurality of pixels arranged in a matrix form with n rows and m columns. Each of the plurality of pixels possesses first to fourth transistors each having a control terminal, a first terminal, and a second terminal, a storage capacitor, and a light-emitting element. The control terminal of the first transistor is electrically connected to the first terminal of the third transistor and one terminal of the storage capacitor. The first terminal of the first transistor is electrically connected to the first terminal of the second transistor and the first terminal of the fourth transistor. The second terminal of the first transistor is electrically connected to the other terminal of the storage capacitor and an anode of the light-emitting element. The second terminal of the second transistor is electrically connected to a respective one of a plurality of power source lines configured to be supplied with a high-level potential and a low-level potential. The driving method is divided into first to fifth periods. In the first period, a reset potential is simultaneously supplied to the first terminals of the first transistors by supplying the low-level potential to the plurality of power-source lines, turning on the fourth transistors, and turning off the second transistors in the plurality of pixels. In the second period following the first period, an initialization potential is simultaneously supplied to the control terminals of the first transistors by turning on the third transistors while maintaining the off state of the second transistors and the low-level potential of the plurality of power-source lines, and then the fourth transistors are turned off in the plurality of pixels. In the third period following the second period, the high-level potential is supplied to the plurality of power-source lines and the second transistors are turned on while maintaining the on state of the third transistors, and then the low-level potential is supplied to the plurality of power-source lines while turning off the second transistors and the third transistors in the plurality of pixels. In the fourth period following the third period, image data is sequentially supplied to the control terminals of the first transistors by turning on the third transistors row-by-row while maintaining the low-level potential of the plurality of power-source lines and the off states of the second transistors and the forth transistors. In the fifth period following the fourth period, the light-emitting elements are made to simultaneously emit light by turning on the second transistors and supplying the high-level potential to the plurality of power-source lines while maintaining the off states of the third transistors and the fourth transistors in the plurality of pixels.

### BRIEF DESCRIPTION OF DRAWINGS

FIG. 1 is a schematic perspective view of a display device according to an embodiment of the present invention;

FIG. 2 is a schematic view showing a structure of a display device according to an embodiment of the present invention;

FIG. 3 is an equivalent circuit of a pixel of a display device according to an embodiment of the present invention;

FIG. 4 is a timing chart of pixels of a display device according to an embodiment of the present invention;

FIG. 5A and FIG. 5B are drawings explaining a driving method of a pixel of a display device according to an embodiment of the present invention;

FIG. 6A and FIG. 6B are drawings explaining a driving method of a pixel of a display device according to an embodiment of the present invention;

FIG. 7 is an equivalent circuit of a pixel of a display device according to an embodiment of the present invention;

FIG. 8 is a schematic view showing a structure of a display device according to an embodiment of the present invention;

FIG. 9 is an equivalent circuit of a pixel of a display device according to an embodiment of the present invention;

FIG. 10 is a timing chart of pixels of a display device according to an embodiment of the present invention;

FIG. 11A and FIG. 11B are drawings explaining a driving method of a pixel of a display device according to an embodiment of the present invention;

FIG. 12A and FIG. 12B are drawings explaining a driving method of a pixel of a display device according to an embodiment of the present invention; and

FIG. 13 is a drawing explaining a driving method of a pixel of a display device according to an embodiment of the present invention.

### DESCRIPTION OF EMBODIMENTS

Hereinafter, the embodiments of the present invention are explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

### First Embodiment

### 1. Structure

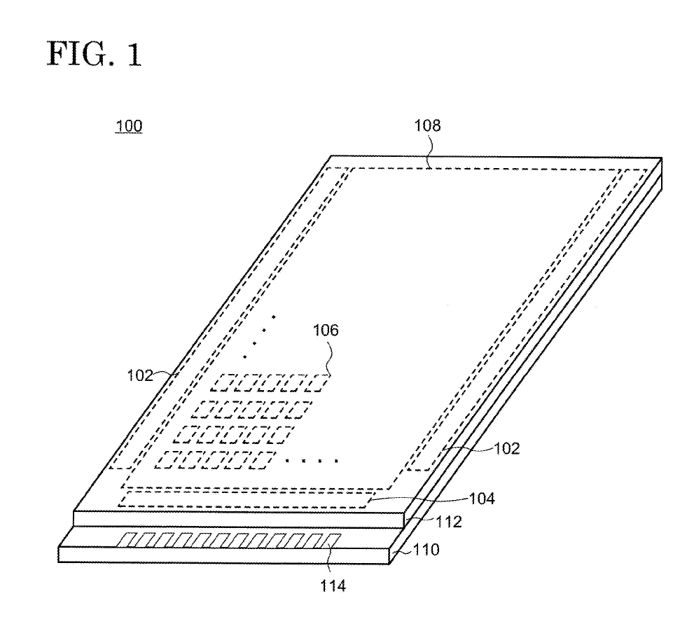

FIG. 1 is a schematic perspective view of a display device 100 according to the First Embodiment of the present invention. The display device has, over one surface (top surface) of a substrate 110, a display region 108 including a plurality of pixels 106 arranged in a row direction and a column direction, scanning-line driver circuits 102, and a data-line driver circuit 104. The display region 108, the scanning-line driver circuits 102, and the data-line driver circuit 104 are disposed between the substrate 110 and an opposing substrate 112. A variety of signals from an external circuit (not illustrated) is input to the scanning-line driver circuits 102 and the data-line driver circuit 104 through a connector such as a flexible printed circuit (FPC) connected to terminals 114 provided over the substrate 110, and each pixel 106 is controlled on the basis of these signals.

Note that one or both of the scanning-line driver circuits 102 and the data-line driver circuit 104 may not be necessarily directly formed over the substrate 110. A driver circuit formed over a substrate (semiconductor substrate or the like) different from the substrate 110 may be arranged over the substrate 110 or the connector to control each pixel 106 with the driver circuit. The substrate 110 and the opposing substrate 112 may be a glass substrate or a flexible resin substrate. A structure may be employed where a resin film or an optical film such as a circular polarizing plate is bonded to the substrate 110 instead of the opposing substrate 112.

A plurality of light-emitting elements emitting light with different colors may be provided in the plurality of pixels 106, for example, by which full-color display can be achieved. For example, light-emitting elements giving red, green, and blue colors can be respectively arranged in three pixels 106. Alternatively, a light-emitting element giving white color is used in all of the pixels 106, and red, green, or blue color is extracted from the respective pixel 106 by using a color filter, thereby performing full-color display. A color finally extracted is not limited to a combination of red, green, and blue colors. For example, four kinds of colors of red, green, blue, and white may be respectively extracted from four pixels 106. There is also no limitation to an arrangement of the pixels 106, and a stripe arrangement, a delta arrangement, and the like can be employed.

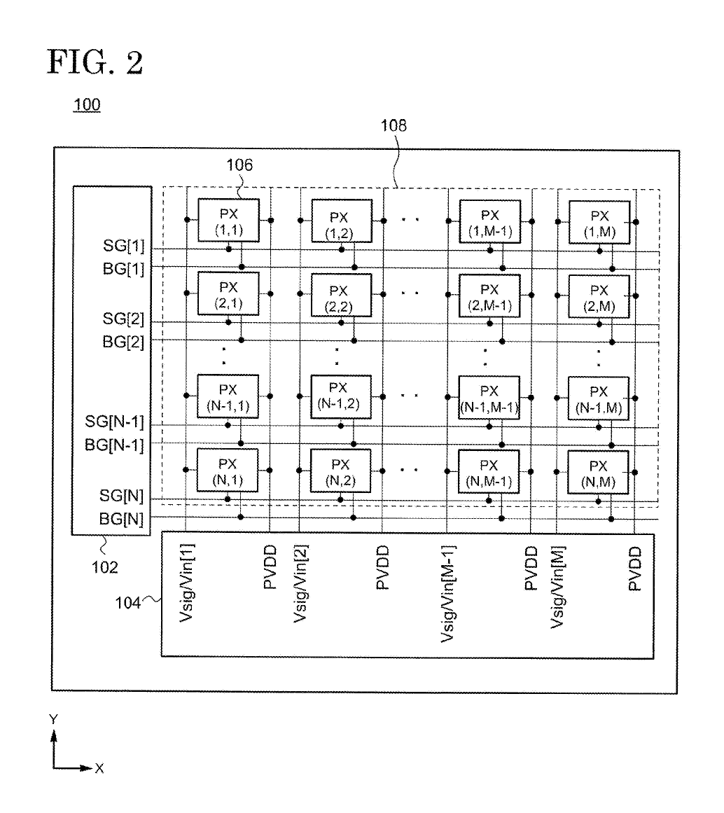

FIG. 2 is a schematic top view of the display device 100. In the present embodiment, an example is explained where the display device 100 is an organic EL display device employing an active-matrix type driving mode. The plurality of pixels 106 is arranged in a matrix form along an X direction and a Y direction perpendicularly intersecting with each other in the display region 108, and a pixel circuit PX is provided in each pixel 106. The following explanation is given for a case in which the matrix is an arrangement of N rows and M columns.

As described below, at least one light-emitting element OLED is arranged in each pixel circuit PX. The scanning-line driver circuit 102 and the data-line driver circuit 104 have a role to form an image by driving the light-emitting element OLED in each pixel circuit PX to emit light.

Specifically, the scanning-line driver circuit 102 possesses scanning-signal lines SG[n] supplying a scanning signal and output-controlling signal lines BG[n] supplying an output-controlling signal commonly to the plurality of pixel circuits PX located in the nth row. n is an integer from 1 to N (the number of rows of the matrix).

The data-line driver circuit 104 possesses image/initializing-signal lines Vsig/Vini[m] supplying image data (image signal) or an initializing signal in a time-division manner and first power-source lines PVDD supplying a power-source potential commonly to the plurality of pixel circuits PX located in the mth line of the matrix structured in the display region 108. m is an integer from 1 to M (the number of columns of the matrix). In the following explanation, the aforementioned reference symbols of the various signal lines imply not only the various signal lines but also the signals and their potentials supplied by the signal lines. That is, the scanning signal and its potential may be represented by SG[n], the output-controlling signal and its potential may be represented by BG[n], the image signal and its potential supplied by the image/initializing-signal lines Vsig/Vini[m] may be represented by Vsig[m], and the initializing signal and its potential may be represented by Vini[m].

The first power source-lines PVDD are configured to supply two kinds of potentials of a high-level potential and a low-level potential in a time-division manner. Hereinafter, the former potential is represented by a high-level potential PVDD(H), and the latter potential is represented by a low-level potential PVDD(L). Although not shown in FIG. 2, a common electrode commonly provided to the pixel circuits PX is arranged in the display region 108, and the data-line driver circuit 104 is configured to have a second power-source line PVSS supplying a constant potential to this common electrode. A potential supplied with the second power-source line PVSS (hereinafter, referred to as a second power-source potential PVSS) may be lower than the high-level potential PVDD(H) supplied with the first power-source potential lines PVDD and may be lower or higher than the low-level potential PVDD(L). The common electrode functions as one electrode (cathode) of the light-emitting elements OLED of the pixel circuits PX and is provided so as to be shared by the plurality of light-emitting elements OLED.

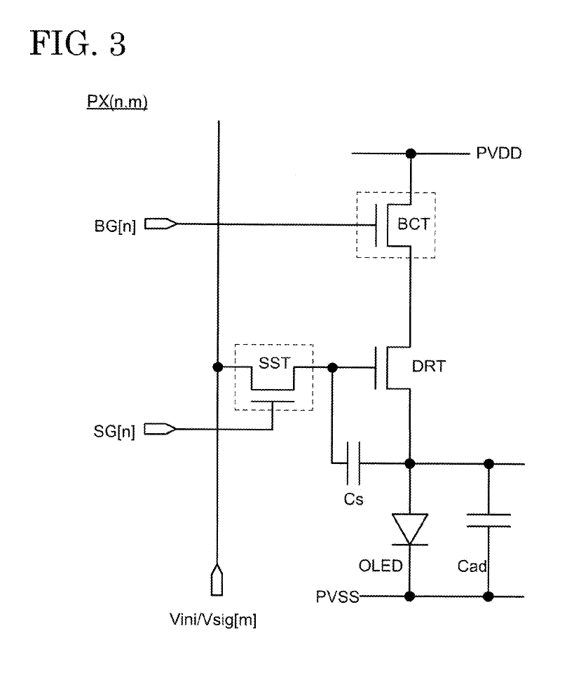

FIG. 3 is an equivalent circuit of the pixel circuit PX shown in FIG. 2. In this figure, a pixel circuit PX(n, m) located in the nth row and mth column of the matrix formed in the display region 108 is shown. However, other pixel circuits PX have the same configuration.

As shown in FIG. 3, the pixel circuit PX has a driving transistor DRT (first transistor), an output-controlling transistor BCT (second transistor), a pixel transistor SST (third transistor), and a storage capacitor Cs in addition to the light-emitting element OLED. The pixel circuit may be further provided with a supplementary capacitor Cad (second storage capacitor) as an optional structure. These transistors each possess a gate, a source, and a drain, and the storage capacitor Cs and the supplementary capacitor Cad have a pair of terminals. In the following explanation, the gate, one of the source and drain, and the other of the source and drain may be represented by a control terminal, a first terminal, and a second terminal, respectively. Additionally, one of the pair of terminals of the storage capacitor Cs and the supplementary capacitor Cad and the other may be represented by the first terminal and the second terminal, respectively. Capacitance of the storage capacitor and that of the supplementary capacitor are also represented by Cs and Cad, respectively.

The control terminal of the driving transistor DRT is electrically connected to the first terminal of the pixel transistor SST and the first terminal of the storage capacitor Cs. The first terminal (drain) of the driving transistor DRT is connected to the power-source line PVDD through the output-controlling transistor BCT. That is, the first terminal of the driving transistor DRT is electrically connected to the first terminal of the output-controlling transistor BCT, and the second terminal of the output-controlling transistor BCT is connected to the power-source line PVDD. The second terminal (source) of the driving transistor DRT is connected to an input terminal (one electrode or anode) of the light-emitting element OLED and the second terminal of the storage capacitor Cs. An output terminal (other electrode or cathode) of the light-emitting element OLED is connected to the second power-source line PVSS. When the supplementary capacitor Cad is provided, the supplementary capacitor Cad may be configured so that the first terminal and the second terminal thereof are connected to the second terminal of the driving transistor DRT and the power-source line PVDD, respectively.

The control terminal of the output-controlling transistor BCT is connected to the output-controlling signal line BG[n], and on and off of the output-controlling transistor BCT is controlled by the output-controlling signal BG[n]. The output-controlling transistor BCT is also called a turning switch. It is possible to set the light-emitting element OLED to a non-emission state by turning off the output-controlling transistor BCT regardless of whether the scanning-signal line SG[n] is at a high level or a low level, that is, whether the image signal Vsig[m] is input to the pixel circuit PX or not. The image/initializing-signal line Vsig/Vini[m] is connected to the second terminal of the pixel transistor, and the image signal Vsig[m] or the initializing signal Vini[m] is supplied thereto in a time-division manner. The scanning-signal line SG[n] is connected to the control terminal of the pixel transistor SST, and on and off of the pixel transistor SST is controlled by the scanning signal SG[n].

In the aforementioned transistors, a channel region can be formed by using a material exhibiting semiconductor properties, such as silicon and an oxide semiconductor. It is preferred that the channel region of the driving transistor DRT include silicon. On the other hand, the channel region of the output-controlling transistor BCT is preferred to include an oxide semiconductor. The pixel transistor SST may also include an oxide semiconductor in the channel region. An oxide semiconductor can be selected from a composite oxide of indium and gallium (IGO), a composite oxide containing indium, gallium, and zinc (IGZO), and the like. A plurality of layers including these materials may be stacked in the channel region.

The channel regions of these transistors may have a variety of morphologies selected from single a crystal, polycrystal, microcrystal, and amorphous state. These morphologies may co-exist in the channel region. In the present embodiment, an example is described where the driving transistor DRT has polysilicon in the channel region, while the pixel transistor SST and the output-controlling transistor BCT have an oxide semiconductor in the channel regions. Hereinafter, a transistor including an oxide semiconductor in a channel region is referred to as an oxide-semiconductor transistor. In the drawings, a transistor explained as an oxide-semiconductor transistor is surrounded by a dotted box.

### 2. Operation

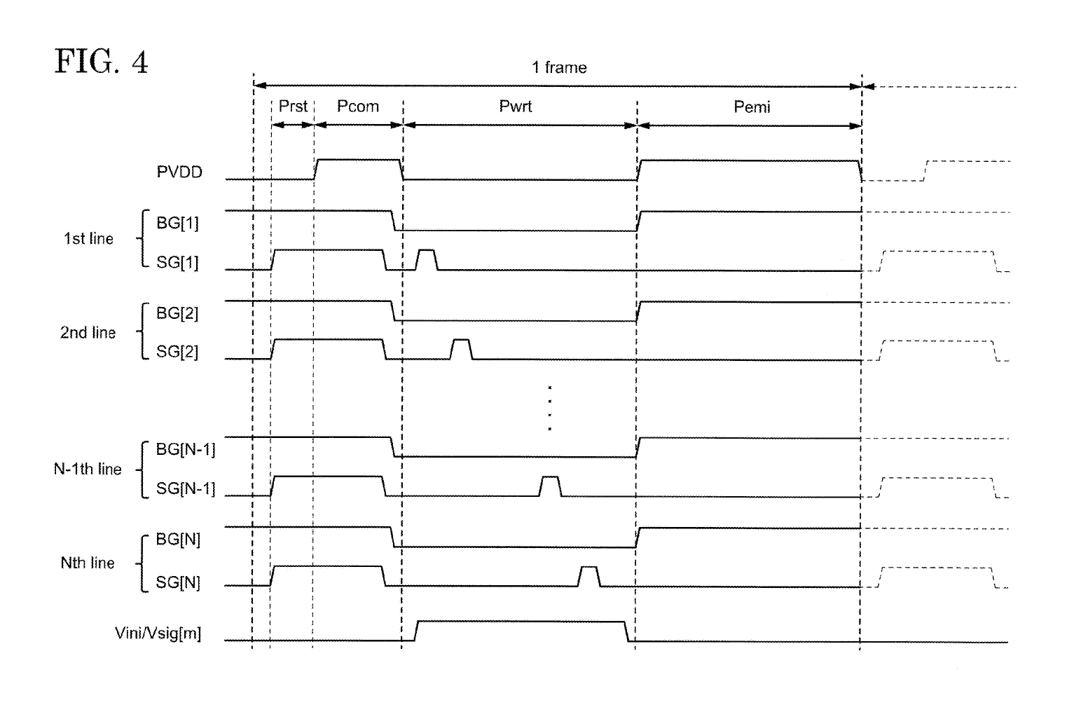

FIG. 4 is a timing chart exhibiting a time change of each signal shown in FIG. 3. Hereinafter, operation of the pixel circuits PX is explained with reference to this chart. Note that, hereinafter, explanation is given for the case where an active state corresponds to a high level. However, whether a high level or a low level is called an active state is arbitrarily determined for each signal. In the present specification, the high level and the low level of the first power-source lines PVDD correspond to the high-level potential PVDD(H) and the low-level potential PVDD(L), respectively. A high level and a low level of the image/initializing-signal line Vsig/Vini[m] correspond to the image signal Vsig[m] and the initializing signal Vini[m], respectively.

In the timing chart shown in FIG. 4, the operations of the pixel circuits PX located in the first, second, (N−1)th, and Nth rows are demonstrated. As shown in FIG. 4, in the operation of the pixel circuits PX[n, m], four operations are performed in one frame. These operations are a reset operation, a threshold-compensating operation, a writing operation, and an emission operation in this order, and the periods corresponding to these operations are called a reset period Prst, a compensation period Pcom, a writing period Pwrt, and an emission period Pemi, respectively.

As shown in FIG. 4, in the reset period Prst, the pixel circuits PX[n, m] located in the first to Nth rows are driven according to the same operation manner. Specifically, after entering the reset period Prst, the scanning-signal line SG[1] in the first row to the scanning-signal line SG[N] in the Nth row simultaneously switch from an inactive state to an active state. At this time, the first power-source lines PVDD, the image/initializing-signal line Vini/Vsig[1], and the output-controlling signal line BG[1] in the first row to the output-controlling signal line BG[N] in the Nth row maintain the states in the immediately preceding frame. Namely, the first power-source lines PVDD maintain the low-level potential PVDD(L), the image/initializing-signal lines Vini/Vsig[m] maintain the initialization potential Vini[m], and the output-controlling signal line BG[1] in the first row to the output-controlling signal line BG[N] in the Nth row maintain an active state. With this operation, the reset operation is simultaneously conducted in the pixels 106 of the first to Nth rows.

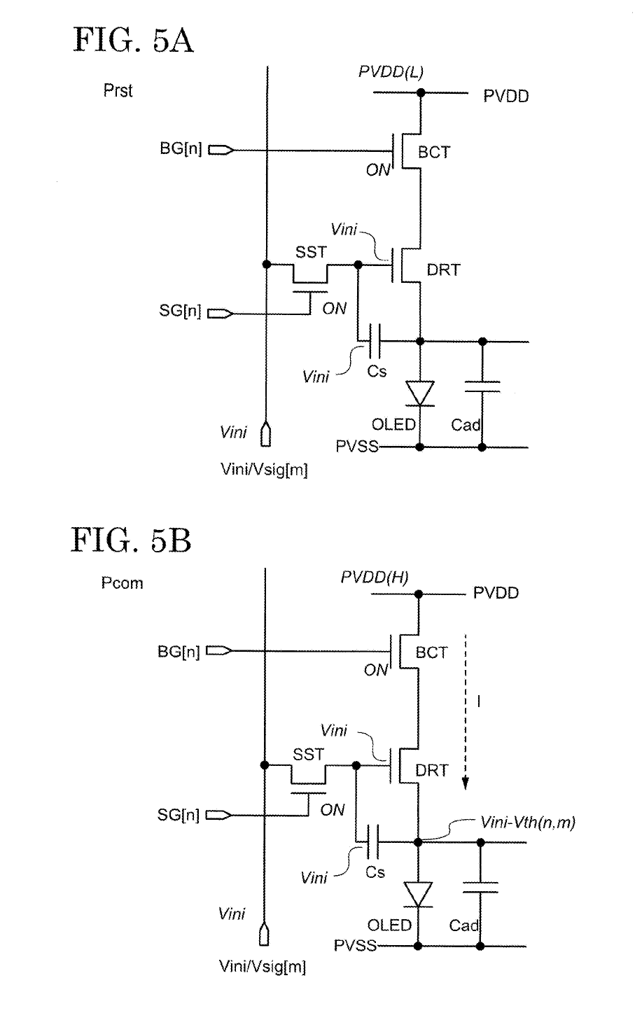

The state at this time is shown in FIG. 5A. In the reset period Prst, the pixel transistor SST and the output-controlling transistor BCT exist in an on state, the low-level potential PVDD(L) is supplied to the first power-source line PVDD, and the initializing signal Vini[m] is supplied to the image/initializing-signal line Vini/Vsig[m]. Therefore, the potential of the control terminal of the driving transistor DRT and the potential of the first terminal of the storage capacitor Cs become Vini.

In this state, the potential of the first power-source lines PVDD switches to the high-level potential PVDD(H) by which the compensation period Pcom is started. The state at this time is shown in FIG. 5B. At this time, a potential difference is generated between the first terminal and the second terminal of the driving transistor DRT, and a current I flows. This current I flows until a charge corresponding to a threshold voltage Vth(n, m) of the driving transistor DRT is accumulated in the storage capacitor Cs. That is, the current I flows until the potential (source potential Vs) of the second terminal of the driving transistor DRT becomes a potential which is lower than the potential (gate potential Vg) of the control terminal of the driving transistor DRT by the threshold voltage Vth(n, m) so as to reach a steady state. Hence, in the steady state, the source potential Vs is Vini[m]−Vth(n, m). On the other hand, since the gate potential Vg maintains the Vini[m], a potential difference Vgs between the gate and the source is Vth(n, m). After that, as shown in FIG. 4, the scanning-signal lines SG[1] to SG[N] and the output-controlling signal lines BG[1] to BG[N] simultaneously switch to an inactive state, and the potential of the first power-source lines PVDD switches to the low-level potential PVDD(L), by which the compensation period Pcom is completed.

After that, the writing period Pwrt is started, and data wring is carried out row-by-row. For example, as shown in FIG. 4, the respective image signal Vsig[m] is sequentially written to the pixel circuit PX[1, m] located in the first row to the pixel circuit PX[N, m] in the Nth row. More specifically, the potential of the image/initializing-signal lines Vsig/Vini[m] switches to the Vsig[m], and the scanning-signal line SG[1] in the first row is pulse-activated, by which the writing of the pixel circuits PX[1, m] in the first row is completed. Next, the scanning-signal line SG[2] of the pixel circuits PX[2, m] in the second row is pulse-activated, by which the writing of the pixel circuits PX[2, m] of this row is completed. The same operation is repeated until the writing operation of the pixel circuits PX[N, m] is completed. The low-level potential PVDD(L) of the first power-source lines PVDD is maintained during the writing period Pwrt.

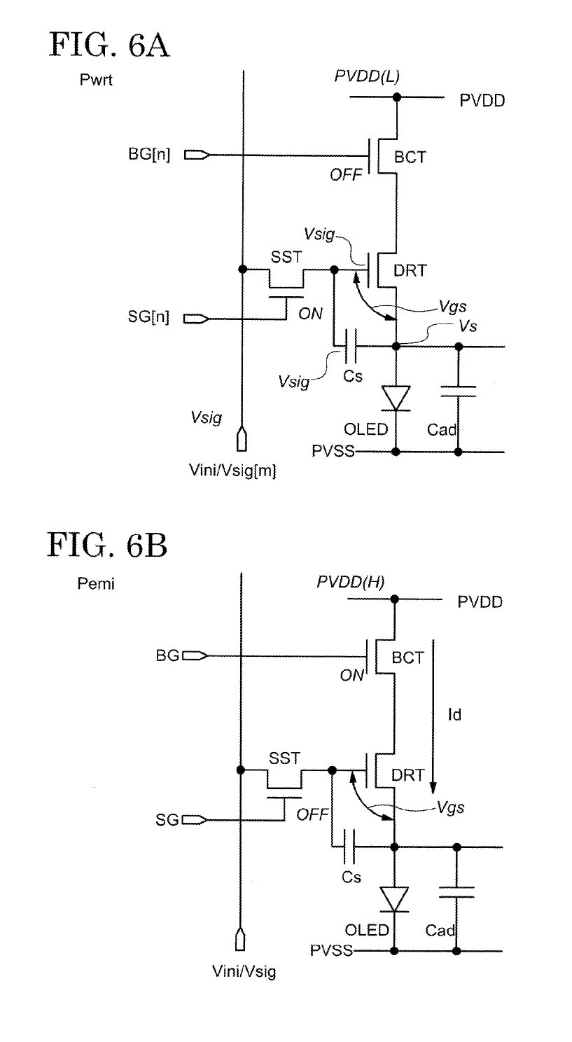

In each pixel circuit PX[n, m], the writing operation provides the image signal Vsig[m] to the control terminal of the driving transistor DRT, which results in variation of the source potential Vs of the driving transistor DRT as shown in FIG. 6A. When the supplementary capacitor Cad is provided, this change depends on capacitance distribution between the storage capacitor Cs and the supplementary capacitor Cad. More specifically, the Vs is expressed by the following equation (1).

$$Vs = Vini [ m ] - Vth ( n , m ) + ( Vsig [ m ] - Vini [ m ] ) \times \frac{Cs}{Cs + Cad} \qquad ( 1 )$$

After the writing period Pwrt is completed, the emission operation is started. Here, as shown in FIG. 4, the pixel circuits PX located in the first to Nth rows are driven according to the same operation manner, and the pixels 106 simultaneously start light emission. Specifically, the output-controlling signal line BG[1] in the first row to the output-controlling signal line BG[N] in the Nth row concurrently switch from an inactive state to an active state, while the potential of the first power-source lines PVDD switches to the high-level potential PVDD(H). After that, the potential of the first power-source lines PVDD is switched to the low-level potential PVDD(L), while maintaining the active state of the output-controlling signal lines BG[1] to BG[N], by which the emission period Pemi is completed. Hence, the pixels 106 located in the first to Nth rows simultaneously start and end the light-emission.

The state at this time is shown in FIG. 6B. Since the output-controlling transistor BCT is in an on state in the emission period Pemi, a current flows from the first power-source line PVDD to the light-emitting element OLED through the output-controlling transistor BCT. Additionally, since the pixel transistor SST is in an off state, the potential Vg of the control terminal of each driving transistor DRT is maintained at the Vsig[m]. Hence, the Vgs of the driving transistor DRT is expressed by the following equation (2).

$$\begin{matrix}Vgs = Vg - Vs \\ = Vsig [ m ] - \{ Vini [ m ] - Vth + ( Vsig [ m ] - Vini [ m ] ) \times \frac{Cs}{Cs + Cad} \} \\ = ( Vsig [ m ] - Vini [ m ] ) \times \frac{Cel}{Cs + Cad} + Vth ( n , m )\end{matrix} \qquad ( 2 )$$

On the other hand, a current Id (source-drain current) flowing from the first terminal to the second terminal of the driving transistor DRT is expressed by the following equation (3):

Id=β{Vgs−Vth(n,m)}² (3)

where the coefficient β is a gain.

Substitution of the Vgs in this equation cancels the Vth(n, m), which proves that the current Id independent from the threshold voltage Vth(n, m) of the driving transistor DRT can be supplied to the driving transistor DRT and the light-emitting element OLED. Therefore, the light-emitting element OLED can be driven with a current independent from the Vth(n, m) without influence of the variation in threshold voltage Vth(n, m), by which luminance variation between the pixel circuits PX is suppressed and a high-quality image can be reproduced.

As described above, the reset operation and the threshold-compensation operation are concurrently performed in all of the pixels 106 in the present embodiment. This operation enables the time required for the reset operation and the threshold-compensation operation of all of the pixel circuits PX to be remarkably reduced compared with a driving method in which the reset operation and the threshold-compensation operation are sequentially conducted in the pixel circuits PX[n, m] arranged in each row. Therefore, a sufficient time for writing the image signal Vsig[m] to all of the pixel circuits PX[n, m] can be secured.

The high functionalization of a display device in recent years is motivated by the requirement of an increase in pixel resolution and high-speed operation in which a display device is operated at a frequency higher than 60 Hz. Such an increase in pixel resolution and employment of the high-speed operation make it difficult to sufficiently secure a writing period of pixel circuits PX[n, m] located in all of the rows. However, the application of the present embodiment allows a sufficient writing period to be secured even if the number of pixels is significantly increased or a frame period is decreased due to the high-speed operation. Hence, the present embodiment is capable of providing a display device with an extremely high resolution, a pixel circuit suitable for a display device driven by the high-speed operation, or a driving method thereof.

Furthermore, the pixel circuit PX[m, n] of the display device 100 according to the present embodiment can be driven with only three transistors. Accordingly, the pixel 106 can be down-sized, which contributes to production of a display device with a higher resolution.

Moreover, in the driving method demonstrated in the present embodiment, all of the pixels 106 simultaneously start light emission and concurrently complete the light emission. Therefore, it is possible to insert a period (black) in which all of the pixels 106 stop light emission into each frame. Thus, it is possible to sharply display a moving image and accurately reproduce high-speed movement.

In addition, in the driving method of the present embodiment, the potential of all of the first power-source lines PVDD is set at the low-level potential PVDD(L) while simultaneously switching the output-controlling signal lines BG[1] to BG[N] to an inactive state in the writing period Pwrt. Hence, an absolute value of the potential difference (the source-drain potential difference) between the first terminal and the second terminal of the output-controlling transistor BCT can be decreased in the writing period Pwrt. When the output-controlling signal lines BG[1] to BG[N] are simultaneously switched to an inactive state in the writing period Pwrt without setting the first power-source lines PVDD at the low-level potential PVDD(L), a leak current is generated in the output-controlling transistor BCT. The leak current results in reduction of accuracy of the threshold compensation. However, since the output-controlling signal lines BG[1] to BG[N] are simultaneously switched to an inactive state while setting all of the first power-source lines PVDD at the low-level potential PVDD(L) in the driving method according to the present embodiment, the leak current can be suppressed. Hence, it is possible to prevent a decrease in accuracy of the threshold compensation. As a result, the Vgs of the driving transistor DRT can be maintained from when writing of the pixels 106 starts until when all the pixels 106 simultaneously emit light. In other words, the image signal Vsig[m, n] written to the driving transistor DRT can be maintained until starting the emission period Pemi. Accordingly, the light-emitting element OLED in each pixel 106 is capable of emitting light at a luminance correctly corresponding to the image signal Vsig[m, n].

In order to prevent reduction of the Vgs in the writing period Pwrt, an operation (offset operation) may be performed in which the potential of the initializing-signal line Vini[m] is further reduced to a potential lower than a potential applied in the compensation period Pcom in a period between the compensation period Pcom and the writing period Pwrt while maintaining the potential of the first power-source lines PVDD at the high-level potential PVDD(H). This offset operation is carried out prior to the operation in which the scanning-signal lines SG[1] to SG[N] are simultaneously switched to an inactive state as shown in FIG. 4. The offset operation maintains the potential of the initializing-signal lines Vini[m], which is decreased in potential to the low potential, immediately until the corresponding scanning-signal line SG[n] is switched to an active state in the writing period Pwrt, i.e., immediately until the writing operation of the corresponding pixels or pixel row is started. Note that the potential of the initializing-signal lines Vini[m] (image/initializing-signal lines Vsig/Vini[m]) is switched from the low potential to the image signal Vsig[m, n] just before the scanning-signal lines SG[n] are switched to an active state in the writing period Pwrt. This offset operation enables suppression of the decrease of Vg of the driving transistor DRT during the period from completing the threshold compensation to starting the writing operation. However, it is necessary to additionally provide a certain period (offset period, transition period) for this offset operation between the compensation period Pcom and the writing period Pwrt. Addition of the offset operation results in a reduction of time allocated for the writing period Pwrt in one frame period. According to the present embodiment, since the output-controlling signal lines BG[1] to BG[N] are simultaneously switched to an inactive state and the potential of all of the first power-source lines PVDD is switched to the low-level potential PVDD(L) in the writing period Pwrt after the compensation period Pcom is completed, it is not necessary to provide the aforementioned offset period and the writing period of all of the pixel circuits PX can be sufficiently secured.

Moreover, an oxide-semiconductor transistor can be employed in the output-controlling transistor BCT and the pixel transistor SST, by which the image signal Vsig[m, n] written to the driving transistor DRT can be more effectively maintained due to the extremely low source-drain current (leak current) in an off state of an oxide-semiconductor transistor.

### Second Embodiment

In the present embodiment, a display device 200 different in structure from the display device 100 is explained. Explanation of the structures the same as those described in the First Embodiment may be omitted.

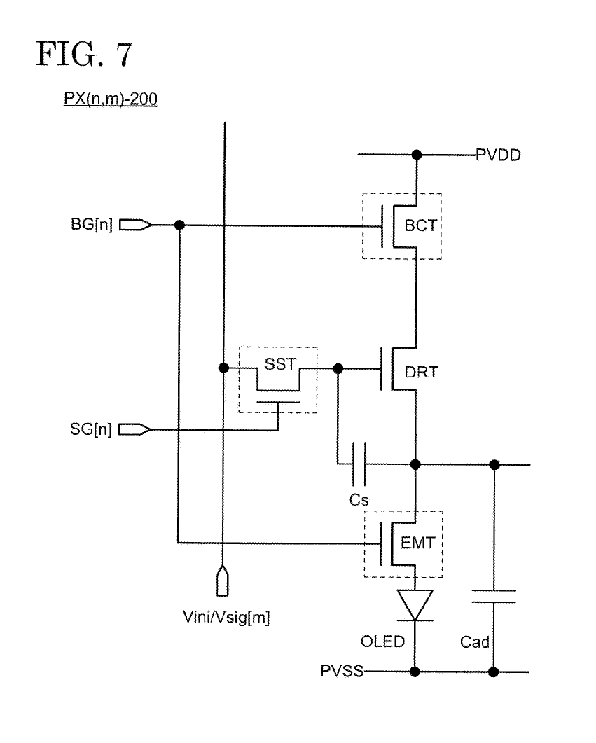

An equivalent circuit of a pixel circuit PX[n, m]−200 of the display device 200 is shown in FIG. 7. The display device 200 is different from the display device 100 in that a transistor (second output-controlling transistor EMT) is disposed between the input terminal of the light-emitting element OLED and the second terminal of the driving transistor DRT and between the input terminal of the light-emitting element OLED and the second terminal of the storage capacitor Cs. More specifically, the second terminal of the driving transistor DRT is electrically connected to a first terminal of the second output-controlling transistor EMT, the input terminal of the light-emitting element OLED is electrically connected to a second terminal of the second output-controlling transistor EMT, and the output-controlling signal line BG[n] is electrically connected to the control terminal of the output-controlling transistor BCT and a control terminal of the second output-controlling transistor EMT. It is preferred that the second output-controlling transistor EMT be an oxide-semiconductor transistor.

The output-controlling transistor BCT and the second output-controlling transistor EMT are subjected to switching between an on state and an off state at the same timing. Therefore, the second output-controlling transistor EMT is also off in the writing period Pwrt. Hence, the second terminal of the driving transistor DRT and the input terminal of the light-emitting element OLED are electrically disconnected in the writing period Pwrt, which enables more effective blocking of a trace current flowing between the second power-source line PVSS and the second terminal of the driving transistor DRT through the light-emitting element OLED. As a result, the image signal Vsig[m] written to the driving transistor DRT can be more effectively maintained during the writing period Pwrt and the emission period Pemi, which contributes to production of a high-quality image.

### Third Embodiment

In the present embodiment, a display device 300 different in structure from the display device 100 is explained. Explanation of the structures the same as those described in the First and Second Embodiments may be omitted.

### 1. Structure

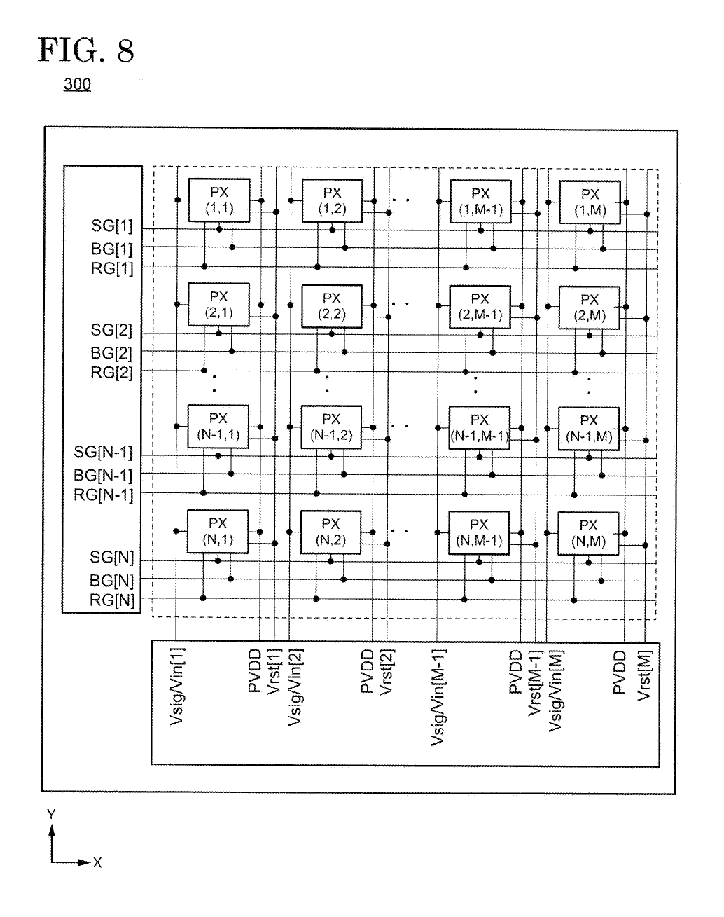

A schematic top view of the display device 300 is shown in FIG. 8. As shown in FIG. 8, the scanning-line driver circuit 102 of the display device 300 is provided with reset-controlling signal lines RG[n] commonly supplying a reset-controlling signal to the plurality of pixel circuits PX located in the nth row. On the other hand, the data-line driver circuit 104 is provided with reset-signal lines Vrst[m] supplying a reset signal. Hereinafter, the reset-controlling signal and its potential are expressed by RG[n], and the reset signal and its potential are expressed by Vrst[m].

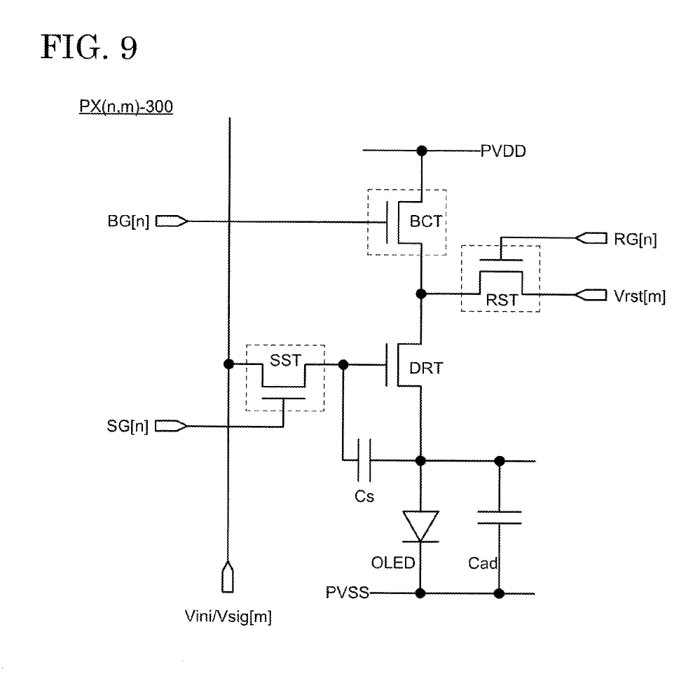

An equivalent circuit PX[n, m]−300 of the pixel circuit PX disposed in the display device 300 is shown in FIG. 9. This equivalent circuit is different from that of the display device 100 in that a reset transistor RST is provided. More specifically, the first terminal of the driving transistor DRT and the first terminal of the output-controlling transistor BCT are electrically connected to a first terminal of the reset transistor RST, and a second terminal and a control terminal of the reset transistor RST are electrically connected to the reset-signal line Vrst[m] and the reset-controlling signal line RG[n], respectively. The reset transistor RST is preferred to be an oxide-semiconductor transistor. Note that a structure may be employed in which the first terminal of the reset transistor RST is electrically connected to the second terminal of the driving transistor DRT, that is, a structure in which the first terminal of the reset transistor RST is connected to a node between the second terminal of the driving transistor DRT and the input terminal of the light-emitting element OLED.

### 2. Operation

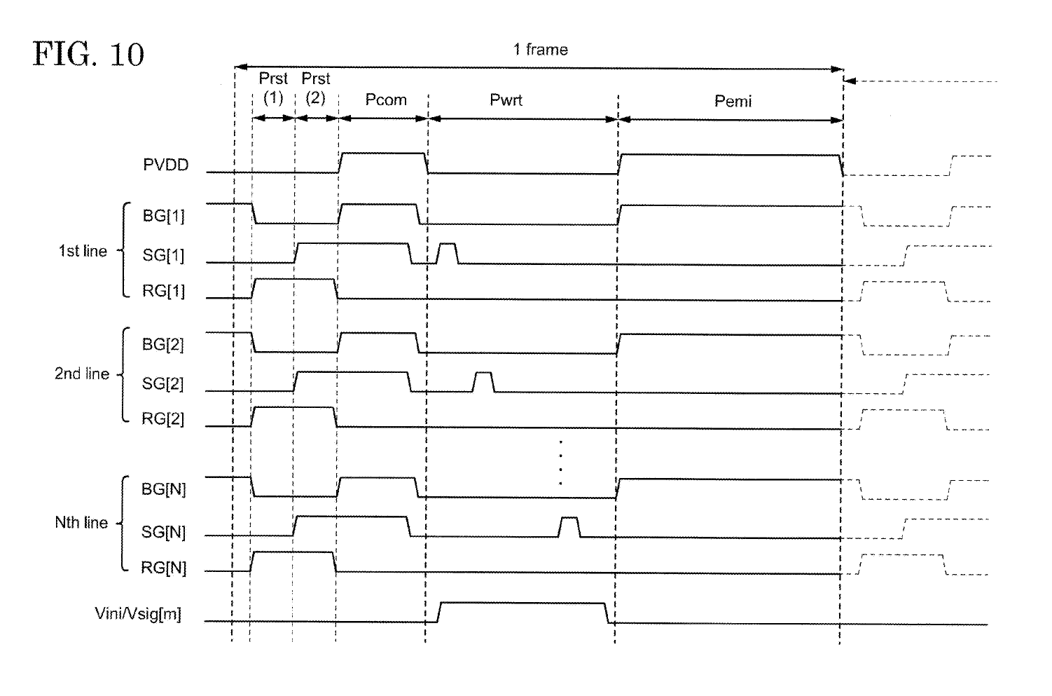

A driving method of the display device 300 is explained by using a timing chart of the pixel circuit PX[n, m]−300 (FIG. 10). Here, a timing chart of the pixel circuits PX in the first row, second row, and Nth row is shown. Similar to the operation of the display device 100, the pixel circuits PX located in the first to Nth rows are simultaneously subjected to the initialization and the threshold compensation and simultaneously undergo the light emission.

Specifically, as shown in FIG. 10, five operations are conducted in one period when the pixel circuits PX[n, m]−300 are driven. These operations are sequentially a first reset operation, a second reset operation, a threshold-compensation operation, a writing operation, and an emission operation, and the periods corresponding to these operations are respectively called a first reset period Prst(1), a second reset period Prst(2), a compensation period Pcom, a writing period Pwrt, and an emission period Pemi. Note that the first reset period Prst(1) and the second reset period Prst(2) are also called a source-initialization period and a gate-initialization period, respectively, and may be collectively recognized as a reset period Prst.

In a frame immediately before entering the first reset period Prst(1), the potential of the first power-source lines PVDD is at the low-level potential PVDD(L), and this potential is also maintained in the first reset period Prst(1). Similarly, in the preceding frame, the image/initializing-signal lines Vsig/Vini[m] are applied with the initializing signal Vini[m], and this potential is also maintained in the first reset period Prst(1). In the preceding frame, the output-controlling signal lines BG[n], the scanning-signal lines SG[n], and the reset-controlling signal lines RG[n] are in an active state, an inactive state, and an inactive state, respectively.

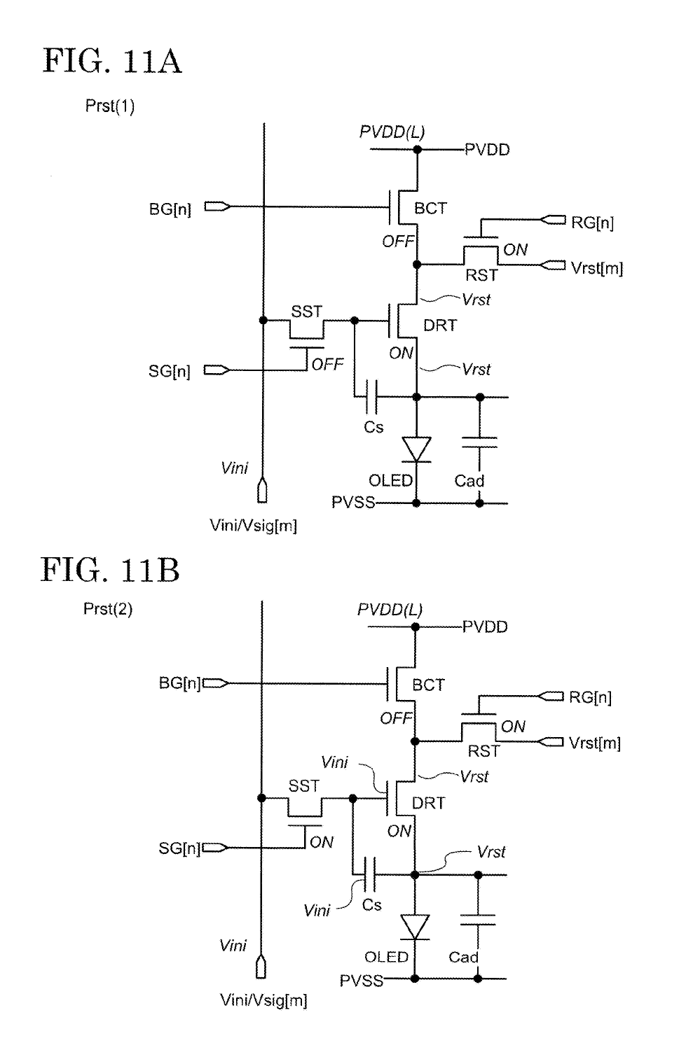

After entering the first reset period Prst(1), a reset operation of the driving transistors DRT is performed in the pixel circuits PX. Specifically, as shown in FIG. 10, the output-controlling signal lines BG[1] to BG[N] and the reset-controlling signal lines RG[1] to RG[N] are switched to an inactive state and an active state, respectively. As a result, as shown in FIG. 11A, the output-transistors BCT are turned off, and the reset transistors RST are turned off in all of the pixel circuits PX. Therefore, the first terminal of each driving transistor DRT is disconnected from the first power-source line PVDD with the output-controlling transistor BCT. The scanning-signal lines SG[1] to SG[N] are maintained in an inactive state, and the pixel transistors SST are maintained in the off state. Furthermore, the reset signal Vrst[m] is supplied to the first terminal of the driving transistor DRT through the reset transistor RST.

At this time, the potential Vrst[m] of each reset signal is set at a potential lower than the potential of the control terminal of the driving transistor DRT so that the driving transistor DRT exists in an on state. Therefore, the first terminal and the second terminal of the driving transistor DRT are reset to the potential which is the same as the potential Vrst[m] of the reset signal. The potential Vrst[m] of the reset signal may be set at a potential lower than the second power-source potential PVSS. However, the potential Vrst[m] of the reset signal is not necessarily lower than the second power-source potential PVSS and may be a potential which does not allow a current to flow in the light-emitting element OLED. Specifically, the potential Vrst[m] of the reset signal may be a potential equal to or lower than a potential which is higher than the second power-source potential PVSS by the threshold Vth(n, m) of the driving transistor DRT. In this state, a current is not supplied to the light-emitting element OLED, and the display device 300 is able to maintain a non-emission state.

After entering the second reset period Prst(2), the scanning-signal lines SG[1] to SG[N] are switched to an active state, and the pixel transistors SST become an on state in all of the pixel circuits PX similar to the first reset period Prst(1). Hence, the control terminals of the driving transistors DRT are connected to the image/initializing-signal lines Vsig/Vini[m] through the pixel transistors SST in all of the pixel circuits PX. At this time, since the image/initializing-signal lines Vsig/Vini[m] are supplied with the initializing signal Vini[m], the control terminals of the driving transistors DRT are supplied with the initialization potential Vini[m] (FIG. 11B).

The initialization potential Vini[m] is set at a potential higher than the potential Vrst[m] of the reset signal. Therefore, the driving transistor DRT exists in an on state, and a current flows between the first terminal and the second terminal until a charge corresponding to a potential difference between the potential Vrst[m] of the reset signal and the initialization potential Vini[m] is accumulated in the storage capacitor Cs since the potential (Vini[m]) of the control terminal is higher than the potential of the first terminal (Vrst[m] at this time) in the driving transistor DRT.

After entering the compensation period Pcom in this state, the threshold-compensation operation is carried out in the pixel circuits PX. Specifically, the reset-controlling signal lines RG[1] to RG[N] become inactive, the output-controlling signal lines BG[1] to BG[N] become active, and the first power-source lines PVDD are switched to the high-level potential PVDD(H) while maintaining the on state of the pixel transistors SST. Therefore, the output-controlling transistors BCT become an on state and the first terminals of the driving transistors DRT are supplied with the high-level power-source potential PVDD(H) through the output-controlling transistors BCT in the pixel circuits PX.

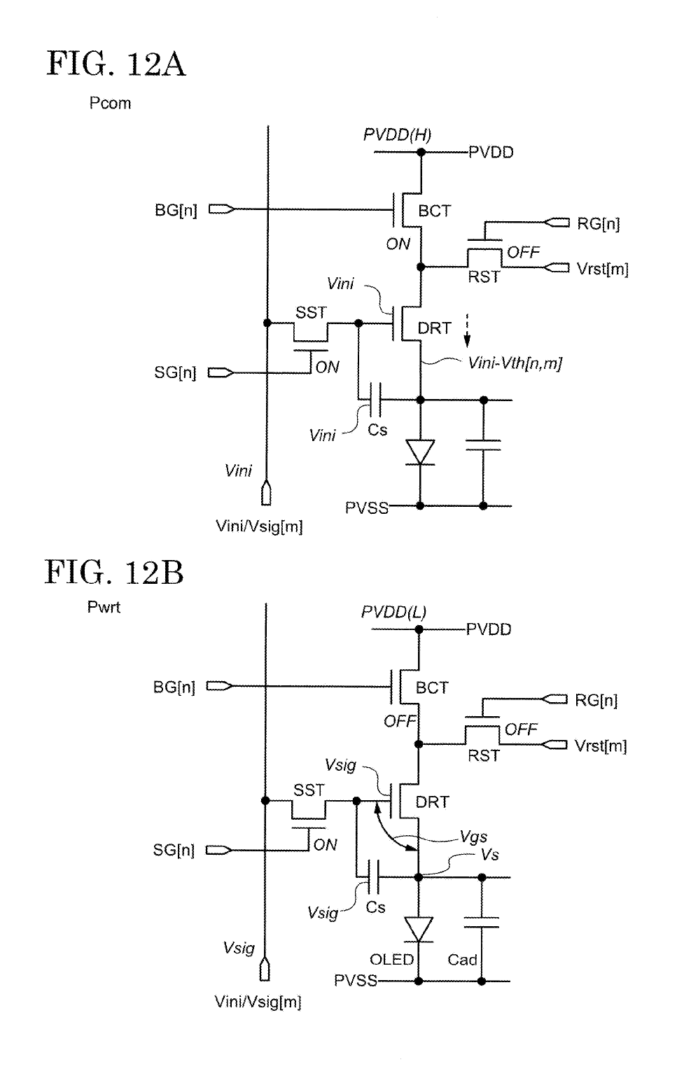

The driving transistor DRT exits in an on state because the control terminal of each driving transistor DRT is continuously supplied with the Vini[m] which is a potential higher than the potential Vrst[m] of the reset signal. Hence, a current flows in the channel of the driving transistor DRT due to the high-level power-source potential PVDD(H) supplied to the first terminal of the driving transistor DRT, resulting in an increase of the potential of the second terminal (see FIG. 12A). When a potential difference between the second terminal and the control terminal reaches the threshold voltage Vth(n. m) of the driving transistor DRT, that is, when the potential of the second terminal reaches Vini[m]−Vth(n, m), the driving transistor DRT is turned off.

When the driving transistor DRT becomes an off state, a charge corresponding to the Vth(n, m) is held in the storage capacitor Cs because Vini[m] is supplied to the first terminal of each storage capacitor Cs and the potential of the second terminal is Vini[m]−Vth(n, m). In other words, information of the threshold Vth(n, m) of the driving transistor DRT is stored in the storage capacitor Cs (FIG. 12A) in the compensation period Pcom. Note that, in order to prevent light emission of the light-emitting element OLED, Vini[m] is preferably adjusted so as to satisfy the following relationship: {(Vini[m]−Vth(n, m))−PVSS(H)}<a threshold voltage of the light-emitting element OLED. Here, the threshold voltage of the light-emitting element OLED is a potential difference between the input terminal and the output terminal when the light-emitting element OLED starts emitting light. After that, the output-controlling signal lines BG[1] to BG[N] and the scanning-signal lines SG[1] to SG[N] become an inactive state, and the first power-source lines PVDD are switched to the low-level potential PVDD(L), entering the sequential writing period Pwrt.

In the writing period Pwrt, the writing operation is performed row-by-row while maintaining the inactive states of the scanning-signal lines BG[1] to BG[N] and the reset-controlling signal lines RG[1] to RG[N] and the low-level potential PVDD(L) of the first power-source lines PVDD. The writing operation is conducted by supplying predetermined image signals Vsig[m] to the image/initializing-signal lines Vsig/Vini[m] and sequentially pulse-activating the corresponding scanning-signal lines SG[m]. The first power-source lines PVDD are maintained at the low-level potential PVDD(L) during the writing period Pwrt.

When the writing operation is carried out, the potential of the control terminal of each driving transistor DRT and the first terminal of the storage capacitor Cs is changed from Vini[m] to Vsig[m]. Accordingly, the potential Vs of the second terminal of the storage capacitor Cs and the second terminal of the driving transistor DRT is increased. The change in potential is determined by the capacitance distribution of the storage capacitor Cs and the supplementary capacitor Cad as described in the First Embodiment and obeys the aforementioned equation (1). In the writing period Pwrt, the potential of the first power-source lines PVDD is maintained at the low-level potential PVDD(L) until the writing operation of the pixel circuits PX in the first to Nth rows is completed (FIG. 12B).

After the writing operation of the pixel circuits in the first to Nth rows is completed, the operation enters the emission period Pemi. Here, as shown in FIG. 10, the pixel circuits PX located in the first to Nth rows are driven according to the same operation manner, and the pixels 106 simultaneously start emitting light. Specifically, the output-controlling signal line BG[1] in the first row to the output-controlling signal line BG[N] in the Nth row are simultaneously switched from an inactive state to an active state, and the potential of the first power-source lines PVDD is switched to the high-level potential PVDD(H). After that, the potential of the first power-source lines PVDD is switched to the low-level potential PVDD(L) while maintaining the active state of the output-controlling signal lines BG[1] to BG[N], by which the emission period Pemi is completed. Hence, the pixels 106 in the first to Nth rows concurrently stop emitting light.

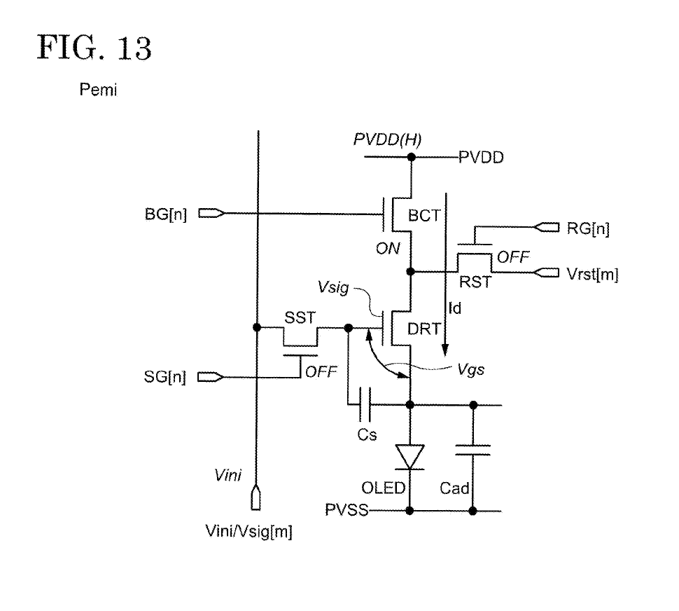

The state at this time is shown in FIG. 13. A current flows from the first power-source line PVDD to the light-emitting element OLED through the output-controlling transistor BCT because the output-controlling transistor BCT exits in an on state in the emission period Pemi. Additionally, the potential (gate potential Vg) Vsig[m] of the control terminal of each driving transistor DRT is maintained because the pixel transistor SST is off. At this time, the Vgs of the driving transistor DRT is a value expressed by the aforementioned equation (2). Hence, a current (source-drain current) Id flowing from the first terminal to the second terminal of the driving transistor DRT also obeys the equation (3) described above. Thus, the current Id independent from the Vth(n, m) is supplied to the driving transistor DRT and the light-emitting element OLED. Hence, the light-emitting element OLED can be driven with a current independent from the Vth(n, m) without influence of the variation of the threshold Vth(n, m), thereby suppressing variation in luminance between the pixel circuits PX(n, m) and reproducing a high-quality image.

The structure and the driving method of the display device 300 according to the present embodiment have the same characteristics as those of the display device 100 described in the First Embodiment. Therefore, it is possible to increase resolution and perform the high-speed operation, which contributes to production of a high-performance display device capable of reproducing a sharp image.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process is included in the scope of the present invention as long as they possess the concept of the present invention.

In the specification, although the cases of the organic EL display device are exemplified, the embodiments can be applied to any kind of display devices of the flat panel type such as other self-emission type display devices, liquid crystal display devices, and electronic paper type display device having electrophoretic elements and the like. In addition, it is apparent that the size of the display device is not limited, and the embodiment can be applied to display devices having any size from medium to large.

It is properly understood that another effect different from that provided by the modes of the aforementioned embodiments is achieved by the present invention if the effect is obvious from the description in the specification or readily conceived by persons ordinarily skilled in the art.

What is claimed is:

1. A driving method of a display device comprising:
a plurality of first transistors each having a control terminal, a first terminal, and a second terminal;
a plurality of light-emitting elements;
a plurality of pixels arranged in a matrix form, the plurality of pixels each including each of the light-emitting elements and each of the first transistors;
at least one power-source line electrically connected to the first terminal; and
at least one turning switch located between the first terminal and the power-source line, wherein each of the first transistors is configured so that image data is input to the control terminal and the second terminal is electrically connected to each of the light-emitting elements,
the driving method comprising;
simultaneously compensating threshold voltages of the first transistors in a first period;
turning off the turning switch while writing the image data to the first transistors row-by-row in a second period following the first period; and
making the light-emitting elements simultaneously emit light in a third period following the second period,
wherein a high-level potential is applied to the power-source line in the first period and the third period, and a low-level potential which is lower than the high-level potential is applied to the power-source line in the second period.

2. The driving method according to claim 1,
wherein the at least one power-source line comprises a plurality of power-source lines,
the at least one turning switch comprises a plurality of turning switches, and
all of the turning switches are turned off and the low-level potential is applied to all of the power-source lines in the second period.

3. The driving method according to claim 1, wherein the turning switch is a second transistor including an oxide semiconductor in a channel region.

4. The driving method according to claim 1, wherein, in each of the pixels, the image data is input to the control terminal through a third transistor including an oxide semiconductor in a channel region.

5. The driving method according to claim 1, wherein each of the pixels comprises a storage capacitor between the control terminal and the second terminal.

6. A driving method of a display device comprising:
a plurality of first transistors each having a control terminal, a first terminal, and a second terminal;
a plurality of second transistors each having a control terminal, a first terminal, and a second terminal;
a plurality of third transistors each having a control terminal, a first terminal, and a second terminal;
a plurality of light-emitting elements each having a first electrode and a second electrode;
a plurality of storage capacitors each having a third terminal and a fourth terminal;
a plurality of pixels arranged in a matrix form, the plurality of pixels each including each of the first transistors, each of the second transistors, each of the third transistors, each of the light-emitting elements, and each of the storage capacitors; and
a plurality of power-source lines configured to be supplied with a high-level potential and a low-level potential which is lower than the high-level potential,
wherein, in each of the pixels:
the control terminal of one of the first transistors is electrically connected to the first terminal of one of the third transistors and the third terminal of one of the storage capacitors;
the first terminal of the one of the first transistors is electrically connected to the first terminal of one of the second transistors;
the second terminal of the one of the first transistors is electrically connected to the fourth terminal of the one of the storage capacitors and the first electrode of one of the light-emitting elements; and
the second terminal of the one of the second transistors is electrically connected to one of the power-source lines,
the driving method comprising;
turning on the third transistors to supply an initialization potential to the first transistors while maintaining an on state of the second transistors and supplying the low-level potential to the power-source lines in the pixels in a first period;
supplying the high-level potential to the power-source lines while maintaining an on state of the second transistors and the third transistors, and then supplying the low-level potential to the power-source lines while turning off the second transistors and the third transistors in the pixels in a second period following the first period;
sequentially supplying image date to the control terminal of each of the first transistors by turning on the third transistors row-by-row in a third period following the second period; and
making the light-emitting elements simultaneously emit light by turning on the second transistors and supplying the high-level potential to the power-source lines while maintaining an off state of the third transistors in the pixels in a fourth period following the third period.

7. The driving method according to claim 6,
wherein all of the second transistors are turned off and the low-level potential is supplied to all of the power-source lines in the third period.

8. The driving method according to claim 6,
wherein each of the second transistors includes an oxide semiconductor in a channel region.

9. The driving method according to claim 6,
wherein each of the third transistors includes an oxide semiconductor in a channel region.

10. The driving method according to claim 6,
wherein each of the pixels comprises a second storage capacitor electrically connected to the second terminal of the one of the first transistors and the second electrode of the one of the light-emitting elements.

11. The driving method according to claim 6,
wherein each of the pixels further comprises a fourth transistor having a control terminal, a first terminal, and a second terminal, and
wherein, in each of the pixels:
the first terminal of the fourth transistor is electrically connected to the second terminal of the one of the first transistors and the second terminal of the fourth transistor is electrically connected to the first electrode of the one of the light-emitting elements; and
the control terminal of the one of the second transistors and the control terminal of the fourth transistor are electrically connected to a same signal line.

12. A driving method of a display device comprising:
a plurality of first transistors each having a control terminal, a first terminal, and a second terminal;
a plurality of second transistors each having a control terminal, a first terminal, and a second terminal;
a plurality of third transistors each having a control terminal, a first terminal, and a second terminal;
a plurality of fourth transistors each having a control terminal, a first terminal, and a second terminal;
a plurality of light-emitting elements each having a first electrode and a second electrode;
a plurality of storage capacitors each having a third terminal and a fourth terminal;
a plurality of pixels arranged in a matrix form, the plurality of pixels each including each of the first transistors, each of the second transistors, each of the third transistors, each of the light-emitting elements, and each of the storage capacitors; and
a plurality of power-source lines configured to be supplied with a high-level potential and a low-level potential which is lower than the high-level potential,
wherein, in each of the pixels:
the control terminal of one of the first transistors is electrically connected to the first terminal of one of the third transistors and the third terminal of one of the storage capacitors;
the first terminal of the one of the first transistors is electrically connected to the first terminal of one of the second transistors and the first terminal of one of the fourth transistors;
the second terminal of the one of the first transistors is electrically connected to the fourth terminal of the one of the storage capacitors and a first electrode of the one of the light-emitting elements; and
the second terminal of the one of the second transistors is electrically connected to one of the power-source lines,
the driving method comprising;
turning on the fourth transistors and turning off the second transistors to simultaneously supply a reset potential to the first terminal of each of the first transistors while supplying the low-level potential to the power-source lines in the pixels in a first period;
simultaneously supplying an initialization potential to the control terminal of each of the first transistors by turning on the third transistors while maintaining an off state of the second transistors and the low-level potential supplied to the power-source lines, and then turning off the fourth transistors in the pixels in a second period following the first period;
supplying the high-level potential to the power-source lines and turning on the second transistors while maintaining an on state of the third transistors, and then supplying the low-level potential to the power-source lines while turning off the second transistors and the third transistors in the pixels in a third period following the second period;
sequentially supplying image data to the control terminal of each of the first transistors by turning on the third transistors row-by-row while maintaining the low-level potential supplied to the power-source lines and an off state of the second transistors and the fourth transistors in a fourth period following the third period; and
making the light-emitting elements simultaneously emit light by turning on the second transistors and supplying the high-level potential to the second transistors while maintaining an off state of the third transistors and the fourth transistors in the pixels in a fifth period following the fourth period.

13. The driving method according to claim 12,
wherein all of the second transistors are turned off and the low-level potential is supplied to all of the power-source lines in the fourth period.

14. The driving method according to claim 12,
wherein each of the second transistors pixels includes an oxide semiconductor in a channel region.

15. The driving method according to claim 12,
wherein each of the third transistors includes an oxide semiconductor in a channel region.

16. The driving method according to claim 12,
wherein each of the fourth transistors includes an oxide semiconductor in a channel region.

17. The driving method according to claim 12,
wherein each of the pixels comprises a second storage capacitor electrically connected to the second terminal of the one of the first transistors and the second electrode of the one of the light-emitting elements.

18. The driving method according to claim 12,
wherein each of the pixels further comprises a fifth transistor having a control terminal, a first terminal, and a second terminal, and
wherein, in each of the pixels:
the first terminal of the fifth transistor is electrically connected to the second terminal of the one of the first transistors;
the second terminal of the fifth transistor is electrically connected to the first electrode of the one of the light-emitting elements; and
the control terminal of the one of the second transistors and the control terminal of the fifth transistor are electrically connected to a same signal line.
